(19) United States
(12) Patent Application Publication
(10) Pub. No.: US 2012/0148923 A1
(43) Pub. Date: Jun. 14, 2012

(54) ELECTROCHEMICAL CELL

(76) Inventors: Hyun-Ki Park, Yongin-si (KR); Ju-Yong Kim, Yongin-si (KR); Jeong-Doo Yi, Yongin-si (KR); Dong-Hee Han, Yongin-si (KR)

(21) Appl. No.: 13/164,588

(22) Filed: Jun. 20, 2011

(30) Foreign Application Priority Data
Dec. 14, 2010 (KR) 10-2010-0127865

(51) Int. Cl. H01M 4/66; H01M 4/64

(52) U.S. Cl. 429/245; 429/233

(57) ABSTRACT

An electrochemical cell includes a housing; a solid electrolyte dividing the housing into a first electrode chamber and a second electrode chamber; a first electrode material accommodated in the first electrode chamber; a second electrode material accommodated in the second electrode chamber; a current collector extending in a first direction in the first electrode chamber; an extended current collector unit extending from the current collector in a second direction; and an electron channel unit on at least one of the current collector and the extended current collector unit.

### CROSS-REFERENCE TO RELATED APPLICATIONS

This application claims priority to and the benefit of Korean Patent Application No. 10-2010-0127865, filed on Dec. 14, 2010, in the Korean Intellectual Property Office, the disclosure of which is incorporated herein in its entirety by reference.

### BACKGROUND

1. Field

One or more embodiments of the present invention relate to an electrochemical cell.

2. Description of the Related Art

Secondary cells such as a sodium (Na)-nickel chloride (NiCl₂) cell, a sodium sulfur (NaS) cell, a nickel metal hydride (NiMH) cell, and a lithium (Li) ion cell are popular due to their high energy density, and are researched as devices for storing power generated by a home power generator, a photovoltaic system, an aerogenerator, etc., or for supplying power to electric vehicles. Secondary cells may be used in high-capacity power saving apparatuses that require a low cost, a long lifetime, a high stability, and a high energy density. Electrochemical cells may store power from several kilowatts (kW) to several megawatts (MW).

### SUMMARY

One or more embodiments of the present invention include an electrochemical cell having a structure for increasing electron mobility.

Additional aspects will be set forth in part in the description which follows and, in part, will be apparent from the description, or may be learned by practice of the presented embodiments.

According to one embodiment of the present invention, an electrochemical cell includes a housing; a solid electrolyte dividing the housing into a first electrode chamber and a second electrode chamber; a first electrode material accommodated in the first electrode chamber; a second electrode material accommodated in the second electrode chamber; a current collector extending in a first direction in the first electrode chamber; an extended current collector unit extending from the current collector in a second direction; and an electron channel unit on at least one of the current collector and the extended current collector unit.

In one embodiment, the electrochemical cell includes a plurality of extended current collector units, wherein the electron channel unit is on an end portion of each of the extended current collector units. In one embodiment, the electron channel unit includes a carbon-based material, for example, carbon felt. In one embodiment, the electron channel unit is physically supported by at least one of the current collector and the extended current collector unit.

In one embodiment, the extended current collector unit includes a current collector supporting unit or a current collector clipping unit, wherein the electron channel unit is supported by the current collector supporting unit or by the current collector clipping unit. Further, the current collector may include a first material, for example, nickel, and a second material having a lower reactivity than the first material, for example, antimony, is coated on the first material.

In one embodiment, the electron channel unit contacts the extended current collector unit. Additionally, the extended current collector unit may be oriented symmetrically with respect to a lateral cross-section of the current collector.

In one embodiment, the electron channel unit includes a metal member and the metal member may be located at a periphery of the electron channel unit. The electrochemical cell may also include current collector wing units extending from the extended current collector unit.

### BRIEF DESCRIPTION OF THE DRAWINGS

These and/or other aspects will become apparent and more readily appreciated from the following description of the embodiments, taken in conjunction with the accompanying drawings of which:

FIG. 1 is a longitudinal cross-sectional view of an electrochemical cell according to an embodiment of the present invention;

FIG. 2 is a graph showing variations in resistance when charge and discharge operations are repeated in a positive electrode chamber of the electrochemical cell illustrated in FIG. 1;

FIG. 3 is a lateral cross-sectional view taken along a line III-III of FIG. 1;

FIG. 4 is a perspective view of an example of an electron channel unit physically fixed to one end of an extended current collector unit in the electrochemical cell illustrated in FIG. 1;

FIG. 5 is a perspective view of a modified example of FIG. 4;

FIG. 6 is a lateral cross-sectional view of a modified example of FIG. 3;

FIGS. 7 through 9 are lateral cross-sectional views of modified examples of FIG. 6;

FIG. 10 is a lateral cross-sectional view of another modified example of FIG. 3; and

FIG. 11 is a lateral cross-sectional view of another modified example of FIG. 3.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

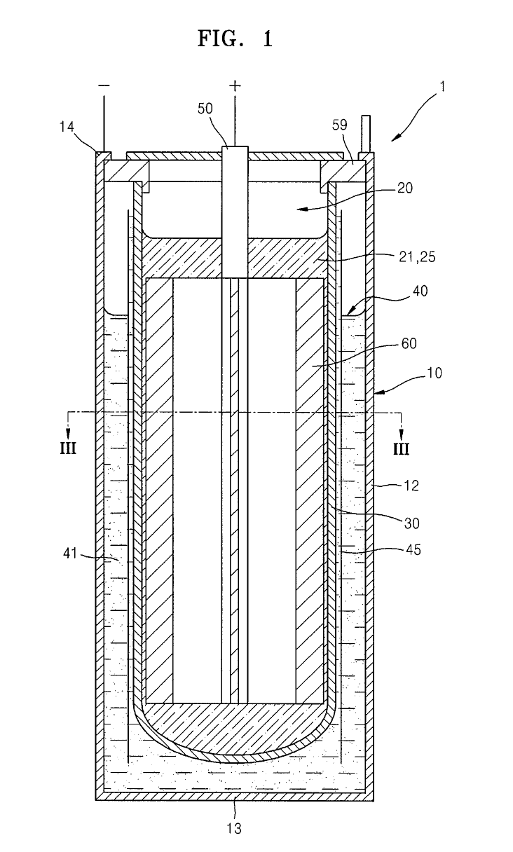

FIGS. 1 and 3 are vertical and horizontal (i.e., longitudinal and lateral, respectively) cross-sectional views, respectively, of an electrochemical cell 1 according to an embodiment of the present invention. That is, FIG. 1 is a cross-sectional view taken along a line I-I of FIG. 3, and FIG. 3 is a cross-sectional view taken along a line III-III of FIG. 1.

Referring to FIG. 1, the electrochemical cell 1 may include a housing 10, a solid electrolyte 30, and a current collector 50.

A region enclosed by the housing 10 may be partitioned by the solid electrolyte 30 into a first electrode chamber 20 and a second electrode chamber 40. Although it is assumed for convenience of explanation that the first electrode chamber 20 is a positive electrode chamber and the second electrode chamber 40 is a negative electrode chamber, the first and second electrode chambers 20 and 40 are not limited thereto.

Referring to FIGS. 1 and 3, the housing 10 may have a hexahedral shape extending in a vertical direction and having a rectangular horizontal cross-section. That is, the housing 10 may include side walls 12 extending in a vertical direction, and a lower wall 13 bent perpendicularly to the side walls 12. An upper wall 14 of the housing 10 is partially open to externally expose the current collector 50 extending from the first electrode chamber 20. However, the shape of the housing 10 is not limited thereto. For example, a horizontal or vertical cross-section of the housing 10 may have one of various shapes such as a polygon, e.g., a rectangle, and a circle, and may have one of various sizes.

The housing 10 may be formed of a conductor such as nickel (Ni) or mild steel. When the second electrode chamber 40 is a negative electrode chamber, the housing 10 may function as a negative electrode current collector.

The solid electrolyte 30 may be accommodated in the housing 10. The solid electrolyte 30 may extend in a vertical direction and may have a tubular shape. The solid electrolyte 30 has a top portion that is open, and a bottom portion that is spaced from the lower wall 13 of the housing 10. The solid electrolyte 30 may have sodium (Na) ion conductivity. The solid electrolyte 30 may be formed of β-alumina, β″-alumina, or a mixture thereof having a high Na ion conductivity. Alternatively, zeolite, feldspar, or Na-ion conducting glass may instead be used.

The first electrode chamber 20 may include a first electrode material. For example, the first electrode chamber 20 may be a negative electrode chamber and thus may include a negative electrode material 41. The negative electrode material 41 may be an alkalic metal such as Na. Na may be in a melted stated as a liquid. Instead of Na, the negative electrode material 41 may be another Group I metal such as lithium (Li) or potassium (K), or a mixture of Na and Li or K.

The second electrode chamber 40 may include a second electrode material. For example, the second electrode chamber 40 may be a positive electrode chamber and thus may include a positive electrode material 21. In one embodiment, the second electrode chamber 40 may further include a liquid electrolyte 25. The positive electrode material 21 may have electrical conductivity and porosity, and may be soaked with the liquid electrolyte 25. The positive electrode material 21 may be a transition metal such as Ni, cobalt (Co), zinc (Zn), chromium (Cr), or iron (Fe). In a charge state, the positive electrode material 21 forms TCl₂. Here, Cl indicates chloride of an electrolyte, and T indicates a transition metal.

The liquid electrolyte 25 may be sodium tetracholoraluminate (NaAlCl₄). NaAlCl₄ may be formed of an equimolar mixture of sodium chloride (NaCl) and aluminium chloride (AlCl₃). The liquid electrolyte 25 may be in a melted state at an operation temperature of the electrochemical cell 1.

The current collector 50 in the first electrode chamber 20 may extend in a first direction. Also, an extended current collector unit 50a (FIG. 3) may extend from the current collector 50 in a second direction. In one embodiment, the first and second directions may be different directions and, particularly, the first and second directions may be substantially perpendicular to each other. For example, the current collector 50 may extend in the first electrode chamber 20 along a vertical direction. That is, the current collector 50 may extend along a longitudinal direction of the housing 10. The extended current collector unit 50a may extend from the current collector 50 along a direction different from the direction in which the housing 10 extends. As noted above, the direction in which the extended current collector unit 50a extends may be substantially perpendicular to the direction in which the current collector 50 extends. The structure of the current collector 50 and the extended current collector unit 50a will be described in detail later. Also, one end of the current collector 50 may be exposed outside the electrochemical cell 1. The current collector 50 may include a metallic material such as Ni.

Electron channel units 60 may be included in the first electrode chamber 20 and may help electrons to easily move to the current collector 50 in the first electrode chamber 20. The electron channel units 60 may allow electrons generated in a charge or discharge operation to easily move from the solid electrolyte 30 toward the current collector 50, or from the current collector 50 toward the solid electrolyte 30.

The electron channel units 60 may include a material having a low reactivity and a high electric conductivity. For example, the electron channel units 60 may include a carbon-based material, and more specifically, the electron channel units 60 may be formed of carbon felt or graphite felt. The carbon felt or the graphite felt may be porous and may be soaked with the liquid electrolyte 25. The electron channel units 60 may include carbon nanotubes or graphene. The electron channel units 60 may be fixed to the extended current collector unit 50a. In one embodiment, the number of the extended current collector units 50a is at least two, and the electron channel units 60 may be located at end portions of the extended current collector unit 50a.

An insulation ring 59 may connect top portions of the solid electrolyte 30 and the housing 10. The insulation ring 59 contacts the top portions of the solid electrolyte 30 and the housing 10, and is bonded to the solid electrolyte 30 by using an adhesive such as glass frit. The insulation ring 59 may be formed of α-alumina.

A plurality of wicks 45 may be located on an outer surface of the solid electrolyte 30. The wicks 45 may be located between and may contact the outer surface of the solid electrolyte 30 and an inner surface of the housing 10, to support the solid electrolyte 30. The wicks 45 may allow a working fluid, such as Na, to move due to a capillary tube phenomenon. Accordingly, for example, even when the second electrode chamber 40 is not completely filled with Na, i.e., the working fluid and the negative electrode material 41, the wicks 45 may allow Na to participate in a reaction on the outer surface of the solid electrolyte 30 during charge and discharge operations.

The above-described electrochemical cell 1 is a secondary cell that is rechargeable and dischargeable, and reactions in charge and discharge operations will now be described briefly. In the charge and discharge operations, the negative electrode material 41 may be Na, the positive electrode material 21 may be Ni, the liquid electrolyte 25 may be NaAlCl₄, and the solid electrolyte 30 may be β-alumina.

In the discharge operation of the electrochemical cell 1, a reaction shown in Reaction Formula 1 may occur in the second electrode chamber 40, here, a negative electrode chamber.

Na→Na⁺+e⁻ (Reaction Formula 1)

Na ions generated according to Reaction Formula 1 may pass through the solid electrolyte 30 and may move to the first electrode chamber 20, here, a positive electrode chamber, thereby participating in a reaction shown in Reaction Formula 2. Meanwhile, electrons generated according to Reaction Formula 1 may move to an external circuit via the housing 10.

Meanwhile, due to an applied potential, electrons may move from the external circuit to the current collector 50 of the first electrode chamber 20. In the first electrode chamber 20, reactions occur according to Reaction Formulae 2 and 3.

Na⁺+Cl⁻→NaCl (Reaction Formula 2)

NiCl₂+2e⁻Ni+2Cl⁻ (Reaction Formula 3)

If the reactions according to Reaction Formulae 2 and 3 occur, Ni ions may be extracted in the first electrode chamber 20. The Ni ions extracted in the first electrode chamber 20 may connect to each other to form an Ni channel between the solid electrolyte 30 and the current collector 50. The electrons moved from the external circuit to the current collector 50 may move to the solid electrolyte 30 via the Ni channel.

In the charge operation of the electrochemical cell 1, a reaction reverse to the reaction in the discharge operation occurs. In the first electrode chamber 20, reactions occur according to Reaction Formulae 4 and 5.

NaCl→Na⁺+Cl⁻ (Reaction Formula 4)

Ni+2Cl⁻→NiCl₂+2e⁻ (Reaction Formula 5)

Referring to Reaction Formula 4, NaCl in the first electrode chamber 20 is decomposed due to an applied potential into Na ions and Cl ions. Referring to Reaction Formula 5, the Cl ions react with Ni to form nickel chloride (NiCl₂) in the first electrode chamber 20 while generated electrons may be supplied to the external circuit. Meanwhile, the Na ions generated according to Reaction Formula 4 may move due to the applied potential via the solid electrolyte 30 to the second electrode chamber 40, here, a negative electrode chamber.

In the second electrode chamber 40, the Na ions may be combined with electrons moved from the external circuit and thus a reaction may occur according to Reaction Formula 6.

Na⁺+e⁻→Na (Reaction Formula 6)

The above-described charge and discharge operations may be briefly represented as Reaction Formula 7.

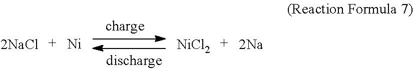

If the charge and discharge operations are repeated according to the Reaction Formulae 1 through 7, a resistance is increased in the first electrode chamber 20. For example, in the charge operation, a reaction occurs according to Reaction Formula 5 such that Ni is transformed into NiCl₂, an overall surface area of Ni is reduced, and thus a surface resistance of Ni is increased. That is, an overall electric conductivity is reduced. In one embodiment, the current collector 50 having a large surface area and the electron channel units 60 for increasing the surface area of the current collector 50 may suppress the increase in resistance in the first electrode chamber 20. In other words, since the surface area of the current collector 50 on which electrons move is increased, the electrons may move freely and thus the resistance may be reduced.

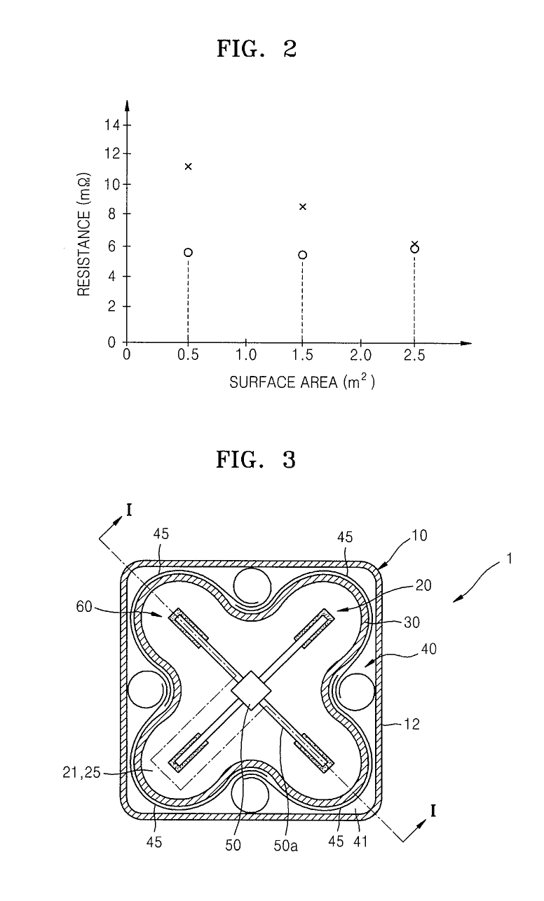

Correlations between resistance and surface area will now be described with reference to FIG. 2. FIG. 2 is a graph showing variations in resistance when charge and discharge operations are repeated in the first electrode chamber 20, here, a positive electrode chamber. In this case, the resistance is measured when the electrochemical cell 1 is in a death of discharge (DOD) state, i.e., when the electrochemical cell 1 has been discharged 80%. Also, the surface area is a sum of surface areas of the current collector 50 and the electron channel units 60. In FIG. 2, O indicates a resistance of a positive electrode of the electrochemical cell 1 in an initial state, and X indicates a resistance of the positive electrode after a charge/discharge cycle is repeated 100 times. After the charge/discharge cycle is repeated 100 times, the resistance is almost doubled when the surface area is 0.5 m² whereas the resistance is only slightly increased when the surface area is 2.5 m². Accordingly, the resistance in the first electrode chamber 20 may be reduced by increasing the surface areas of the current collector 50 and the electron channel units 60 of the electrochemical cell 1.

Accordingly, the current collector 50 may include the extended current collector unit 50a, and the electron channel units 60 may be fixed to the current collector 50 or the extended current collector unit 50a. The extended current collector unit 50a and the electron channel units 60 will now be described with reference to FIG. 3.

The electron channel units 60 may reduce paths of electrons in the first electrode chamber 20. That is, the electron channel units 60 may be soaked with the liquid electrolyte 25, and thus may help electrons to easily move to the current collector 50.

Electrons generated in a charge operation due to a reaction occurring in the first electrode chamber 20 may move to the current collector 50 via the electron channel units 60 and the extended current collector unit 50a, and then may move to an external circuit connected to the current collector 50. In this case, the electron channel units 60 and the extended current collector unit 50a may have one of various structures to increase their surface areas in the first electrode chamber 20. The various structures will be described in detail later. Since the electron channel units 60 and the extended current collector unit 50a have relatively large surface areas, electrons generated due to a reaction occurring relatively far from the current collector 50 may also move to the current collector 50 without being lost and thus an overall charge efficiency of the electrochemical cell 1 may be improved.

In a discharge operation of the electrochemical cell 1, a reaction in the first electrode chamber 20 starts in a region of the first electrode chamber 20 adjacent to the solid electrolyte 30 and spreads toward a central region of the first electrode chamber 20. In this case, electrons moved from the external circuit to the current collector 50 may move to the electron channel units 60 or the extended current collector unit 50a in order to participate in the reaction. Since the electron channel units 60 and the extended current collector unit 50a are widely spread in the first electrode chamber 20, electrons adjacent to the solid electrolyte 30 may also easily participate in the reaction.

The current collector 50 may include a first material, and a second material having a reactivity lower than the first material may be coated on the first material. For example, the current collector 50 may be formed of Ni. In one embodiment, the current collector 50 may be coated with a material having a reactivity lower than Ni so that Ni does not participate in reactions occurring in charge and discharge operations. For example, the current collector 50 may be coated with antimony (Sb) having a standard potential higher than Ni and thus having a reactivity lower than that of Ni. Accordingly, although the charge and discharge operations are performed in the first electrode chamber 20, Ni forming the current collector 50 does not participate in reactions.

The extended current collector unit 50a may be oriented symmetrically with respect to a direction in which the current collector 50 extends. In FIG. 3, four extended current collector unit 50a are oriented symmetrically with respect to the current collector 50. However, the number of the extended current collector units 50a is not limited thereto and may be six or more or less. A cross-section of the extended current collector unit 50a may have a generally cross (+) shape, or may have a Y shape or an asterisk (*) shape, or any other suitable shape.

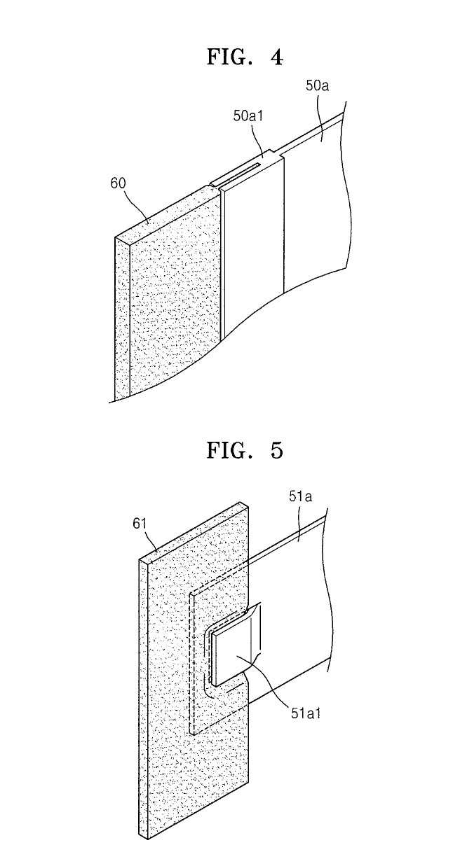

In one embodiment, the electron channel units 60 may be physically connected to the current collector 50 or the extended current collector unit 50a. The connection of the electron channel units 60 will now be described with reference to FIGS. 4 and 5. FIG. 4 is a perspective view of an example of one electron channel unit 60 physically fixed to one end of one current collector extending unit 50a in the electrochemical cell 1 illustrated in FIG. 1.

Referring to FIG. 4, two current collector fixing units 50a1 may extend from the one end of the current collector extending unit 50a to fix the electron channel unit 60. However, the method of fixing the electron channel unit 60 to the current collector extending unit 50a is not limited thereto. FIG. 5 is a perspective view of a modified example of FIG. 4. Referring to FIG. 5, a current collector clipping unit 51a1 may be formed at one end of a current collector extending unit 51a to physically support an electron channel unit 61. In this case, the current collector extending unit 51a and the electron channel unit 61 may extend onto each other to increase their contact area. Accordingly, a resistance may be reduced and the stability of physical connection may be increased between the current collector extending unit 51a and the electron channel unit 61.

In FIGS. 4 and 5, the electron channel units 60 and 61 are respectively fixed to the extended current collector unit 50a and 51a. However, alternatively, the electron channel units 60 and 61 may be connected to the current collector 50.

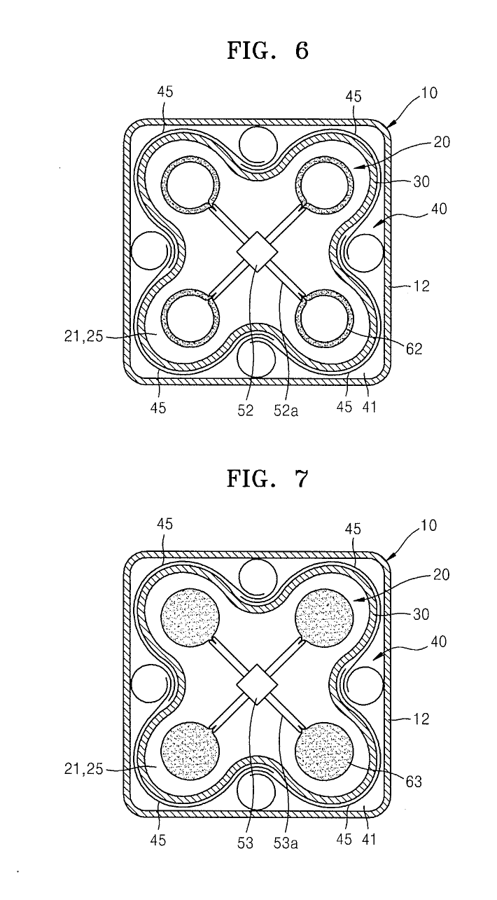

Referring back to FIGS. 1 and 3, the electron channel units 60 may contact closely to the extended current collector unit 50a. However, the contact between the electron channel units 60 and the extended current collector unit 50a is not limited thereto, and will now be described with reference to FIGS. 6 through 8.

FIG. 6 is a horizontal cross-sectional view of a modified example of FIG. 3. Referring to FIG. 6, the first electrode chamber 20 may accommodate a current collector 52, extended current collector unit 52a, and electron channel units 62. In this case, the electron channel units 62 may have a ring shape and may be connected to the extended current collector unit 52a. As such, the electron channel units 62 may be widely spread in the first electrode chamber 20 and thus may help electrons to easily move to the current collector 52.

FIG. 7 is a horizontal cross-sectional view of a modified example of FIG. 6. Referring to FIG. 7, the first electrode chamber 20 may accommodate a current collector 53, extended current collector unit 53a, and electron channel units 63. In this case, the electron channel units 63 may be formed by filling inner spaces of the electron channel units 62 illustrated in FIG. 6. In other words, the electron channel units 62 illustrated in FIG. 6 may have a ring shape and may be soaked with the liquid electrolyte 25, and the electron channel units 63 illustrated in FIG. 7 may have inner spaces soaked with the liquid electrolyte 25.

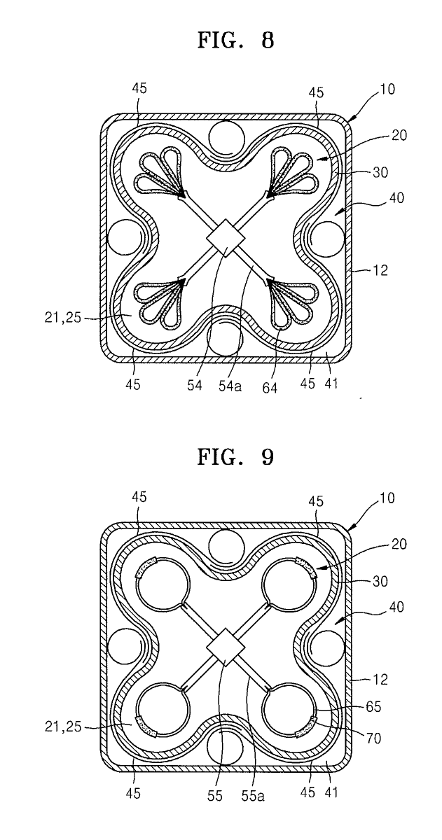

FIG. 8 is a horizontal cross-sectional view of another modified example of FIG. 6. Referring to FIG. 8, the first electrode chamber 20 may accommodate a current collector 54, extended current collector units 54a, and electron channel units 64. Here, the electron channel units 64 may have a plurality of ring shapes and may be connected to the extended current collector unit 54a. As such, the electron channel units 64 may have a larger surface area. In one embodiment, inner spaces of the electron channel units 64 may be filled.

FIG. 9 is a horizontal cross-sectional view of another modified example of FIG. 6. Referring to FIG. 9, the first electrode chamber 20 may accommodate a current collector 55, extended current collector units 55a, and electron channel units 65. The electron channel units 65 may include metal members 70. The metal members 70 may be located on outer sides of the electron channel units 65 by using, for example, silver (Ag). The metal members 70 may further increase electron mobility. In addition to Ag, the metal members 70 may be formed of copper (Cu), gold (Au), aluminum (Al), magnesium (Mg), Zn, or Fe.

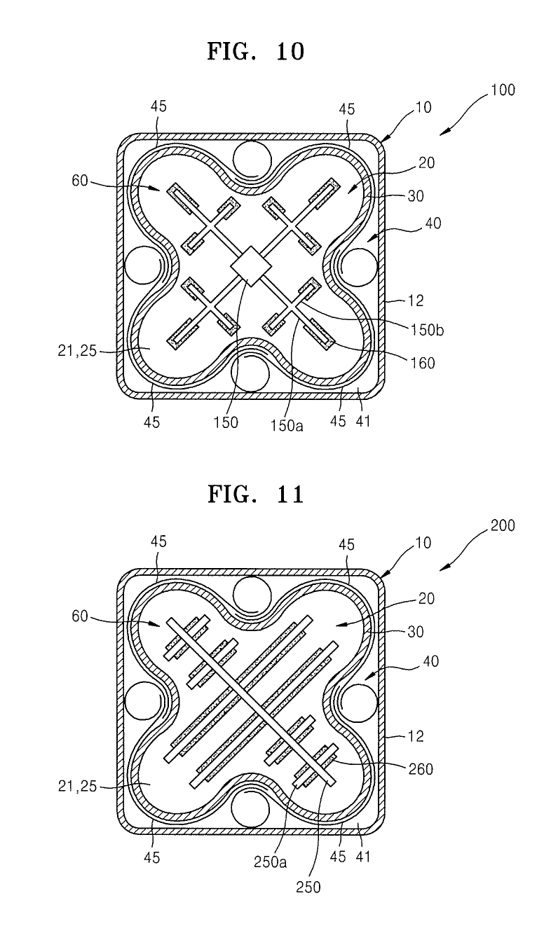

FIG. 10 is a horizontal cross-sectional view of another modified example of FIG. 3. Referring to FIG. 10, the first electrode chamber 20 of an electrochemical cell 100 may accommodate a current collector 150, extended current collector unit 150a, and electron channel units 160. In this case, current collector wing units 150b may extend from the extended current collector unit 150a. The electron channel units 160 may be fixed to the current collector wing units 150b and to the extended current collector unit 150a. Although a pair of the current collector wing units 150b extends from each of the extended current collector unit 150a in FIG. 10, the number of current collector wing units 150b extending from each of the extended current collector unit 150a is not limited thereto. In other words, in order to increase an overall surface area of the current collector 150, a plurality of the current collector wing units 150b may extend from the extended current collector unit 150a in a tree structure.

FIG. 11 is a horizontal cross-sectional view of another modified example of FIG. 3. Referring to FIG. 11, the first electrode chamber 20 of an electrochemical cell 200 may accommodate a current collector 250, extended current collector unit 250a, and electron channel units 260. In this case, the current collector 250 may extend in one direction and the extended current collector unit 250a may by symmetrically formed with respect to the current collector 250. Also, instead of end portions of the extended current collector unit 250a, the electron channel units 260 may be fixed to central portions of the extended current collector unit 250a close to the current collector 250.

As described above, according to the one or more of the above embodiments of the present invention, a resistance in a positive electrode chamber of an electrochemical cell may be reduced and thus the efficiency of the electrochemical cell may be improved.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. An electrochemical cell comprising:
a housing;
a solid electrolyte dividing the housing into a first electrode chamber and a second electrode chamber;
a first electrode material accommodated in the first electrode chamber;
a second electrode material accommodated in the second electrode chamber;
a current collector extending in a first direction in the first electrode chamber;
an extended current collector unit extending from the current collector in a second direction; and
an electron channel unit on at least one of the current collector and the extended current collector unit.

2. The electrochemical cell of claim 1, comprising a plurality of extended current collector units, wherein the electron channel unit is on an end portion of each of the extended current collector units.

3. The electrochemical cell of claim 1, wherein the electron channel unit comprises a carbon-based material.

4. The electrochemical cell of claim 3, wherein the electron channel unit comprises carbon felt.

5. The electrochemical cell of claim 1, wherein the electron channel unit is physically supported by at least one of the current collector and the extended current collector unit.

6. The electrochemical cell of claim 5, wherein the extended current collector unit comprises a current collector supporting unit, and wherein the electron channel unit is supported by the current collector supporting unit.

7. The electrochemical cell of claim 5, wherein the extended current collector unit comprises a current collector clipping unit, and wherein the electron channel unit is supported by the current collector clipping unit.

8. The electrochemical cell of claim 1, wherein the current collector comprises a first material, and
wherein a second material having a lower reactivity than the first material is coated on the first material.

9. The electrochemical cell of claim 8, wherein the current collector comprises nickel, and wherein antimony is coated on the nickel.

10. The electrochemical cell of claim 1, wherein the electron channel unit has a ring shape and is connected to the extended current collector unit.

11. The electrochemical cell of claim 1, wherein the electron channel unit contacts the extended current collector unit.

12. The electrochemical cell of claim 1, wherein the first direction and the second direction are different directions.

13. The electrochemical cell of claim 12, wherein the first direction and the second direction are substantially perpendicular to each other.

14. The electrochemical cell of claim 1, wherein the extended current collector unit is oriented generally symmetrically with respect to a lateral cross-section of the current collector.

15. The electrochemical cell of claim 14, wherein a lateral cross-section of the extended current collector unit has a generally cross shape.

16. The electrochemical cell of claim 1, wherein the electron channel unit comprises a metal member.

17. The electrochemical cell of claim 16, wherein the metal member is located at a periphery of the electron channel unit.

18. The electrochemical cell of claim 1, further comprising current collector wing units extending from the extended current collector unit.
